(19) United States
(12) Patent Application Publication
(10) Pub. No.: US 2025/0371382 A1
(43) Pub. Date: Dec. 4, 2025

(54) SYSTEM AND METHOD FOR ACCELERATING DEEP LEARNING INFERENCE

(71) Applicant: Black Sesame Technologies Inc., San Jose, CA (US)

(72) Inventors: Jin Liu, Santa Clara, CA (US); Jiaji Liu, Saratoga, CA (US); Mingqiu Gu, San Jose, CA (US); Xiuyuan Bi, Santa Clara, CA (US)

(73) Assignee: Black Sesame Technologies Inc., San Jose, CA (US)

(21) Appl. No.: 18/677,648

(22) Filed: May 29, 2024

(51) Int. Cl. G06N 5/04; G06F 9/50; G06N 7/01

(52) U.S. Cl. CPC G06N 5/04; G06F 9/5027; G06N 7/01

(57) ABSTRACT

The disclosure provides a system and method for reducing inference latency of an artificial intelligence (AI) system. During operation, the system can obtain an AI model and compile the AI model to generate at least one Directed Acyclic Graph (DAG), which comprises determining an offset address associated with a piece of intermediate data to be transferred from a primary memory shared among multiple AI accelerators to a secondary memory. The AI accelerators, the primary memory, and the secondary memory are located on the same system on a chip (SoC). The system can then schedule computing tasks, which comprises determining a base address associated with the DAG in the secondary memory, and perform inference based on the DAG, which comprises transferring the piece of intermediate data from the primary memory to the secondary memory based on the offset address and the base address.

### BACKGROUND

### Field

This disclosure generally relates to machine learning technologies. More specifically, the disclosed system and method relate to reducing the inference time of a neural network by reducing the data-loading latency.

### Related Art

Low latency and high throughput are essential requirements for ensuring the safety, reliability, and efficiency of autonomous vehicles operating in dynamic real-world environments. More specifically, the latency and throughput associated with the perception of the environment and the decision-making process can directly impact the system's ability to detect obstacles and react to changing traffic conditions, hazards, and unpredictable events.

Autonomous driving systems typically rely on machine learning models to perceive the environment and make decisions. With the development of sensor and machine learning technologies, learning models used in autonomous driving are trending toward larger and more complex models. As these models expand, managing vast amounts of data in a memory-constrained, real-time system becomes challenging.

Autonomous driving systems perform real-time inference (i.e., the process of applying a trained model to new data to make predictions or decisions), which can involve storing and accessing information (e.g., input, model parameters, activation tensors, etc.) from memory. For large models, external data storage units, such as Random-Access Memory (RAM) or Solid-State Drives (SSDs) are needed due to the limited size of the internal memory of the computing unit performing the inference. During inference, a massive amount of data needs to be transferred between the external data storage unit and the computing unit. For example, at the beginning of the interference, the computing unit can read input data and the model parameters (e.g., weights) from a storage unit (e.g., a Double Data Rate Synchronous Dynamic Random-Access Memory (DDR SDRAM) and store them in its internal memory (e.g., a static RAM (SRAM)). While performing the inference, the computing unit may spill intermediate results (e.g., activation tensors) from its memory to the external storage unit and read them back later when needed. After the inference, the computing unit can write the output data into the external storage unit.

Transferring large amounts of data between the computing unit's internal memory and the external storage unit can introduce long delays, especially in situations of limited bandwidth.

### SUMMARY

One embodiment can provide a system and method for reducing inference latency of an artificial intelligence (AI) system. During operation, the system can obtain an AI model and compile the AI model to generate at least one Directed Acyclic Graph (DAG), which comprises determining an offset address associated with a piece of intermediate data to be transferred from a primary memory shared among multiple AI accelerators to a secondary memory. The AI accelerators, the primary memory, and the secondary memory are located on the same system on a chip (SoC). The system can then schedule computing tasks for the inference, which comprises determining a base address associated with the DAG in the secondary memory; and perform the inference, which comprises transferring the piece of intermediate data from the primary memory to the secondary memory based on the offset address and the base address.

In a variation on this embodiment, the primary memory or the secondary memory includes a static random-access memory (SRAM).

In a variation on this embodiment, receiving the AI model can include storing weight files associated with the AI model in an off-chip memory.

In a further variation, the system can preload, prior to the inference, at least a portion of the weight files from the off-chip memory into the secondary memory, thereby reducing the inference latency resulting from loading the weight files into the primary memory to allow the multiple AI accelerators to perform computations based on the weight files.

In a further variation, the system can preload one or more weight files associated with a second model into the secondary memory.

In a variation on this embodiment, performing the inference can include loading weight files associated with the DAG into the primary memory, and loading the weight files can include skipping a weight file that pre-exists in the primary memory.

In a further variation, skipping the weight can include determining that the DAG remains unchanged from a previous inference, determining that a base address in the primary memory corresponding to the DAG remains unchanged from the previous inference, and determining that the weight file is persistent during the previous inference.

In a further variation, generating the DAG can include generating a memory operator associated with the weight file and setting a persistent bit in the memory operator.

In a further variation, scheduling the computing tasks can include generating a data-loading command associated with the DAG and setting a skip_weight bit in the data-loading command.

One embodiment can provide a computing system comprising a processor and a memory coupled to the processor and storing instructions that when executed by the processor cause the processor to perform a method for reducing inference latency of an artificial intelligence (AI) system. The method can include: obtaining an AI model; compiling the AI model to generate at least one Directed Acyclic Graph (DAG), which comprises determining an offset address associated with a piece of intermediate data to be transferred from a primary memory shared among multiple AI accelerators to a secondary memory, wherein the AI accelerators, the primary memory, and the secondary memory are located on a same system on a chip (SoC); scheduling computing tasks for the inference, which comprises determining a base address associated with the DAG in the secondary memory; and performing the inference based on the DAG, which comprises transferring the piece of intermediate data from the primary memory to the secondary memory based on the offset address and the base address.

One embodiment can provide an artificial intelligence (AI) system. The AI system can include a plurality of AI accelerators, a primary memory shared among multiple AI accelerators, and a secondary memory. The AI accelerators, the primary memory, and the secondary memory are located on the same system on a chip (SoC). The AI system can include an AI compiler to compile an AI model to generate at least one Directed Acyclic Graph (DAG), which comprises determining an offset address associated with a piece of intermediate data to be transferred from the primary memory to the secondary memory, a task-scheduling unit to schedule computing tasks for the inference, which comprises determining a base address associated with the DAG in the secondary memory, and data-loading firmware to transfer, during the inference, the piece of intermediate data from the primary memory to the secondary memory based on the offset address and the base address.

### DESCRIPTION OF THE FIGURES

FIG. 1 illustrates the architecture of an exemplary machine learning system, according to one embodiment of the instant application.

FIG. 2 illustrates the hardware block diagram of an exemplary machine learning system, according to one embodiment of the instant application.

FIG. 3A illustrates an exemplary scenario of spilling intermediate data to on-chip memory (OCM), according to one embodiment of the instant application.

FIG. 3B presents a flowchart illustrating an exemplary process for performing inference, according to one embodiment of the instant application.

FIG. 4 presents a flowchart illustrating an exemplary process for preloading weights to on-chip memory, according to one embodiment of the instant application.

FIG. 5 illustrates an exemplary scenario of splitting the weights between on-chip and off-chip memories, according to one embodiment of the instant application.

FIG. 6 illustrates an exemplary scenario of preloading weights of multiple models, according to one embodiment of the instant application.

FIG. 7 illustrates an exemplary weight-reuse scenario, according to one embodiment of the instant application.

FIG. 8 presents a flowchart illustrating an exemplary process for skipping the loading of a weight file, according to one embodiment of the instant application.

FIG. 9 illustrates an exemplary latency-reduction apparatus for autonomous driving applications, according to one embodiment of the instant application.

FIG. 10 illustrates an exemplary computer system for performing inference with reduced latency, according to one embodiment of the instant application.

In the figures, like reference numerals refer to the same figure elements.

### DETAILED DESCRIPTION

The following description is presented to enable any person skilled in the art to make and use the disclosed embodiments and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

### Overview

The disclosure describes a system and method for shortening the data-loading time to reduce the inference latency of machine learning models used for autonomous driving applications. To reduce the latency caused by accessing an external storage unit, an SoC (system on a chip)-based machine learning system can include, in addition to the shared memory (SHMEM) traditionally used by Artificial Intelligence (AI) accelerators, a secondary memory unit (implemented as an on-chip memory (OCM)) with address mapped into the same address space as the external storage unit to buffer data traditionally stored in the external storage unit. During inference, instead of the external storage unit, the AI engines can buffer intermediate data in the OCM, thus reducing the time needed for loading the data for later usage. In addition, model parameters (e.g., weights) can be preloaded from the external storage unit into the OCM, either fully or partially. To further reduce the inference latency, the system can identify weights stored in the SHMEM from previous inferences that can be reused during the current inference and skip those weights while loading model parameters from the external storage unit or the OCM. Collaborations among the AI compiler, the task-scheduling unit, and the data-loading firmware are needed to implement the latency-reduction solution.

### Latency Reduction Via OCM

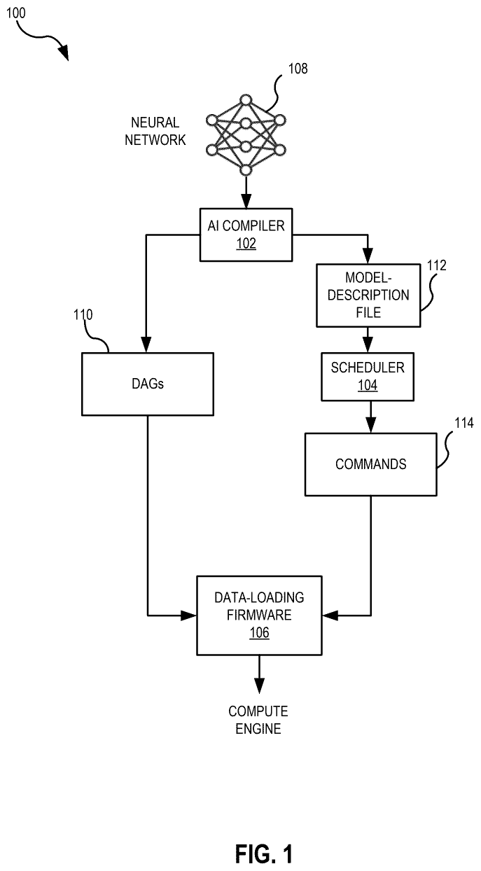

FIG. 1 illustrates the architecture of an exemplary machine learning system, according to one embodiment of the instant application. In FIG. 1, a machine learning system 100 can include an AI compiler 102, a scheduler 104, and data-loading firmware 106.

AI compiler 102 can be responsible for transferring and optimizing high-level AI models into low-level instructions that can be executed by target AI engines. A typical AI compiler can take a machine learning model generated by a machine learning framework (e.g., PyTorch) and convert the model into a computational graph representation (e.g., a Directed Acyclic Graph (DAG)). In the example shown in FIG. 1, AI compiler 102 can receive an AI model (e.g., a neural network) 108 and output one or more DAGs 110. A DAG can be used to define the representation and execution of the AI model. For example, each node in the DAG may represent a layer of neurons or computing units, and the edges represent the flow of information between layers. In addition to the nodes and the operations at each node, the DAG file can also include the offset address of data (e.g., input, weights, activation tensors, etc.) to be written into memories.

In addition to the DAGs, AI compiler 102 can output a model-description file 112 to inform scheduler 104 of necessary information about AI model 108. Model-description file 112 can include various parameters associated with the AI model, such as the size of the weights learned during the training process and representing the strength of connections between the neurons in different layers. In some embodiments, AI compiler 102 can also be responsible for determining the timing and amount of intermediate data to be transferred out of the internal memory. AI compiler 102 can also determine the offset address of the intermediate data (e.g., the activation tensors) based on the size of the data. In addition to the size of the weights, model-description file 112 can also include information about the size of the input, output, and intermediate data. In some embodiments, model-description file 112 can be a Meta file. Other file formats can also be possible.

Scheduler 104 can be responsible for scheduling tasks (e.g., computing tasks and data-loading tasks) to achieve the goal of high throughput and low latency. Scheduler 104 can parse model-description file 112 to generate a set of commands 114 to be sent to data-loading firmware 106. In some embodiments, scheduler 104 can be used to determine the base address of model data (e.g., DAGs, tensors, weights, activations, etc.) stored in memories (including both internal and external memories) to prevent address conflicts. In other words, scheduler 104 is responsible for allocating memory space for storing data needed during inference.

Data-loading firmware 106 can be responsible for loading data into and from memories. For example, data-loading firmware 106 can parse DAGs 110 and commands 114 to determine a memory address for reading or writing data. If the data needed for a computing task is stored in an on-chip memory (OCM), data-loading firmware 106 can load the data from the OCM. In some embodiments, data-loading firmware 106 can compute the memory address of a piece of data based on the base address provided by scheduler 104 and the offset address provided by AI compiler 102.

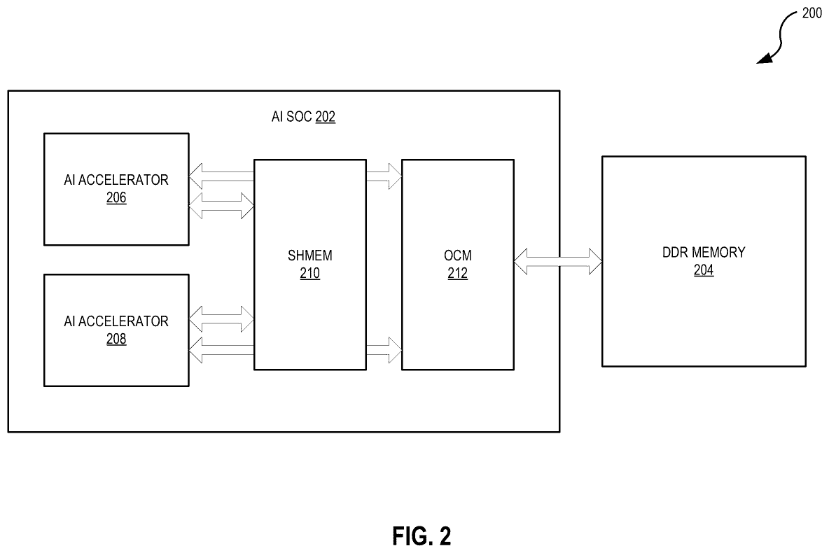

FIG. 2 illustrates the hardware block diagram of an exemplary machine learning system, according to one embodiment of the instant application. In FIG. 2, a machine learning system 200 can include an AI SOC 202 and an off-chip DDR DRAM device 204. For simplicity, the off-chip DDR DRAM device 204 can be referred to as off-chip DDR memory 204. AI SOC 202 can include one or more Al accelerators (e.g., accelerators 206 and 208), a shared memory 210, and an OCM 212. In an alternative example, AI SOC 202 can also include a central processing unit (CPU).

AI accelerators 206 and 208 have been designed specially to accelerate the execution of AI workloads, such as matrix multiplications, convolutions, and activation functions. Shared memory (SHMEM) 210 can be shared among the AI accelerators and can include static RAMs (SRAMs) associated with AI accelerators 206 and 208. Each accelerator can treat SHMEM 210 as its internal memory that can be directly accessed. In one example, the size of SHMEM 210 can be 64 MB or larger. SHMEM 210 can also be referred to as the primary memory of the accelerators.

OCM 212 can have their addresses mapped into the same address space of the off-chip DDR memory 204. In some embodiments, OCM 212 can be implemented using SRAMs. In alternative embodiments, OCM 212 can be implemented using DRAMs. The CPU (not shown in FIG. 2) and the AI accelerators of machine learning system 200 can access OCM 212 the same way as they access off-chip DDR memory 204 but using a different address. Because OCM 212 is located on the same chip (i.e., SOC 202) as the AI accelerators, the latency for accessing OCM 212 can be less than that for accessing DDR memory 204. Moreover, DDR memory 204 is typically shared with other computational resources in the system (e.g., other applications running on the CPU). When the entire system is running, DDR contention can arise, thus greatly reducing the actual accessing bandwidth of the AI accelerators to DDR memory 204. In contrast, OCM 212 is located on SOC 202 and is unaffected by other applications in the system. Therefore, even though the bandwidths needed for reading and writing to DDR memory 204 and OCM 212 are similar, accessing bandwidth to OCM 212 can be stable, whereas accessing bandwidth to DDR memory 204 may be affected by other applications. OCM 212 can also be referred to as the secondary memory of the accelerators.

According to some aspects of the instant application, to accelerate data transfer during inference, SHMEM 210 can be configured to spill or buffer intermediate data (e.g., activation tensors) to OCM 212, instead of the off-chip DDR memory 204. When needed, the intermediate data can be read back to SHMEM 210 from OCM 212. The low latency and stable bandwidth for accessing OCM 212 can improve the inference efficiency of machine learning system 200. Moreover, model parameters (e.g., weights) can be preloaded from the off-chip DDR memory 204 into OCM 212.

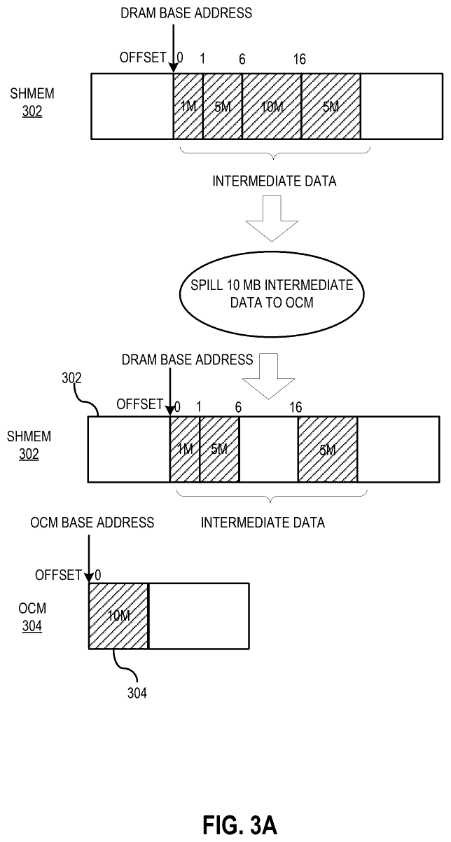

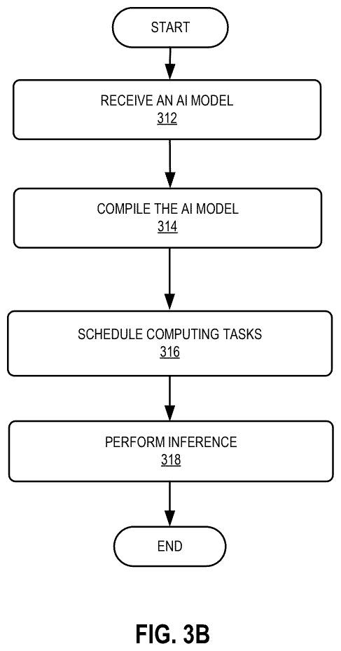

FIG. 3A illustrates an exemplary scenario of spilling intermediate data to on-chip memory (OCM), according to one embodiment of the instant application. In the example shown in FIG. 3A, the AI accelerators generate intermediate data (e.g., activation tensors) during inference and send the intermediate data to a shared memory (SHMEM) 302. Due to its limited size, SHMEM 302 can transfer (or spill) a certain amount of intermediate data to OCM 304. In one embodiment, either SHMEM 302 or OCM 304 can include an SRAM. In an alternative embodiment, both SHMEM 302 and OCM 304 can include an SRAM.

The AI compiler (e.g., compiler 102 in FIG. 1) is aware of the size of the data moving in and out of SHMEM 302 and can accordingly determine the offset address of each piece of data. In addition to the offset address, the AI compiler can also select, from six groups of base addresses, a base address group to indicate the data type and the type of memory for storing the data. The six groups can include a group 0 for storing input parameters in the off-chip DDR memory, a group 1 for storing weights in either the off-chip DDR memory or the OCM, a group 2 for storing the intermediate data in the off-chip DDR memory, a group 3 for storing the model output in the off-chip DDR memory, a group 4 for storing the spilled intermediate data and preloaded weights in the OCM, and a reserved group 5. Therefore, when generating a DRAM operator for spilling the intermediate data, the AI compiler can set the address-select field in the DRAM operator to indicate that the group 4 base address is selected.

The scheduler (e.g., scheduler 104 in FIG. 1) can determine the base address for storing the intermediate data based on the selected group of base addresses, and the data-loading firmware (e.g., firmware 106 in FIG. 1) can calculate the actual address for storing the intermediate data based on the base address and the offset address. For example, the firmware can calculate the actual address according to: Address=BaseAddress [GroupIndex]+offset, where the BaseAddress is provided by the scheduler and the GroupIndex and the offset address is provided by the AI compiler. GroupIndex corresponds to the selected group among the aforementioned six groups of base addresses.

For large models that generate large amounts of intermediate data that cannot entirely fit into SHMEM 302, the AI compiler can transfer or spill intermediate data that is not immediately needed to OCM 304 to reduce latency during inference. The spilled data can be reloaded from OCM 304 back to SHMEM 302 when needed. More specifically, the AI compiler can determine the timing and amount of data to be transferred or spilled to the OCM. In the example shown in FIG. 3A, the AI compiler can determine that 10 MB of intermediate data is to be transferred or spilled from SHMEM 302 to OCM 304.

In some embodiments, the AI compiler can generate a DRAM operator that can perform the data-transfer operation. The DRAM operator can include the offset address, which is determined by the AI compiler based on the DAG associated with the AI model. The DRAM operator can also include an address-select field that indicates to the firmware to use the OCM base address. The compiler can also generate a meta file associated with the model and include, in the meta file, the peak memory usage of OCM 304.

The scheduler can parse the meta file to obtain the maximum usage of OCM 304 by the AI model during inference. If OCM 304 has enough space (e.g., the maximum usage is less than available memory space in OCM 304), the scheduler can assign the OCM base address. In one embodiment, the scheduler can generate a data-loading command to be sent to the firmware, the command including the OCM base address. In some embodiments, if OCM 304 does not have enough space, the scheduler can generate an error notification that indicates the requested space (i.e., the peak usage) and the space available in OCM 304. In alternative embodiments, if OCM 304 does not have enough space, the scheduler can allocate the data to the off-chip DDR memory. For example, the scheduler can generate a data-loading command to be sent to the firmware, the command including the DDR base address.

The firmware can parse the command from the scheduler and the DAG and then perform the data-transfer operation. In the example shown in FIG. 3A, the firmware can read 10 MB of intermediate data from a memory location in SHMEM 302 and write the data to a memory location (e.g., a location specified by the data-loading command and the DRAM operator) in OCM 304.

FIG. 3B presents a flowchart illustrating an exemplary process for performing inference, according to one embodiment of the instant application. During operation, the system can receive an AI model (operation 312) and compile the AI model (operation 314). When receiving the AI model, the system can store system parameters (e.g., weights) in an off-chip storage device (e.g., a DDR). Compiling the model can result in one or more DAGs, with each DAG comprising a plurality of nodes and each node associated with one or more memory operators. Moreover, to implement the latency reduction scheme that spills intermediate data (e.g., activation tensors) from the primary memory (i.e., the SHMEM) of the AI accelerators to a second memory (e.g., an OCM), the compiler can determine the offset address (i.e., the size) of a piece of intermediate data to be spilled from the primary memory (e.g., the SHMEM) shared among multiple AI accelerators to the secondary memory (e.g., the OCM). Because the AI accelerators, the primary memory, and the secondary memory are located on the same system on a chip (SoC), the data-loading latency associated with the intermediate data can be much less compared with traditional systems, where the intermediate data is spilled to an off-chip memory device (e.g., a DDR).

In some embodiments, when generating the memory operators associated with a node (e.g., a DRAM operator for loading weights into the SHMEM), the compiler can use a persistent bit in the DRAM operator to indicate whether a weight file associated with this node will be overwritten by other nodes in the DAG. Note that, when compiling the model, the compiler can determine how the weights are to be loaded into the SHMEM. The DRAM operator can include the offset addresses (i.e., the sizes) of the weight files. If the DRAM operator is generated for spilling intermediate data to the OCM, it can include the offset address of the to-be-spilled intermediate data.

The system can subsequently schedule various computing tasks needed for the inference (operation 316). In some embodiments, scheduling the computing tasks can involve allocating space in the secondary memory for spilling the intermediate data and preloading weights. In one embodiment, scheduling the computing tasks can include determining a base address in the secondary memory for storing data (e.g., intermediate data or weights) associated with the DAG.

The system can perform the inference based on the DAG (operation 318). While performing the inference, intermediate data can be generated by accelerators and sent to the primary memory. Due to its limited size, the primary memory may spill a certain amount of intermediate data into the secondary memory. More specifically, the intermediate data can be transferred from the primary memory to the secondary memory based on the offset address (determined during the model compiling) of the intermediate data and the base address (determined during the task scheduling) of the secondary memory.

In addition to using the OCM to buffer the intermediate data during inference, one can also preload model parameters (e.g., weights) into the OCM such that, when needed, the weights can be loaded into the SHMEM from the on-chip OCM instead of the off-chip DDR, thus further reducing the inference latency. The ability to preload weights into the OCM can reduce the time needed for reading the weights during inference, especially in scenarios when multiple models run in parallel. Preloading the weights into the OCM also requires collaboration among the compiler, the scheduler, and the data-loading firmware.

In certain scenarios, weights from one or more models (each model represented by one or more DAGs) can be fully loaded into the OCM. In such a case, the weight preload can be managed solely by the scheduler, and the compiler does not need to be aware of the usage of OCM. The compiler can compile the AI models as usual with the assumption of using the DDR to store weights. For example, the compiler can select the group of DDR addresses as the base address for storing the weights and calculate the size of the weights. The compiler can also include the size of the weights in the meta file.

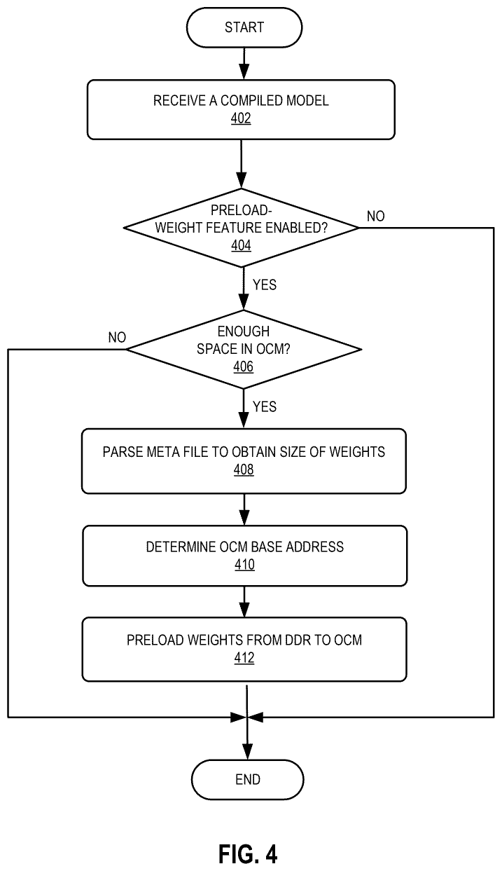

The preload-weight feature can be toggled by a configuration file of the system. If the feature is enabled, the scheduler can initiate the weight-preload operation. FIG. 4 presents a flowchart illustrating an exemplary process for preloading weights to the on-chip memory, according to one embodiment of the instant application. During operation, the scheduler receives a compiled model from the compiler (operation 402). As discussed previously, the compiler compiles the model without knowledge of the weight preload. The compiled model can include a DAG file and a meta file. The DAG file can specify a number of DRAM operators (e.g., read and write operators), the selected group of base addresses (e.g., OCM or DDR), and the offset address. The meta file can include a unique identifier of the model, the size of the weights, and the memory usage (e.g., the peak OCM usage for storing the intermediate data).

The scheduler can determine whether the preload-weight feature is enabled (operation 404). If not, the operation ends, and no weight is preloaded to the OCM. Otherwise, the scheduler can determine whether there is enough space in the OCM to preload all weights associated with the model (or DAG) into the OCM (operation 406). If not, the operation ends. Otherwise, the scheduler can parse the meta file to obtain the size of the weights (operation 408). An OCM memory allocation logic within the scheduler can determine the OCM base address for preloading the weights (operation 410). The scheduler can then proceed to preload the weights from the DDR to the OCM (operation 412). In some embodiments, the preloading of the weights can occur at the beginning of the first frame of the inference. During inference, the scheduler can include the OCM base address in the command executable by the data-loading firmware. The data-loading firmware can parse the command and the DAG to load the weights from the OCM into the SHMEM to facilitate the execution of the model.

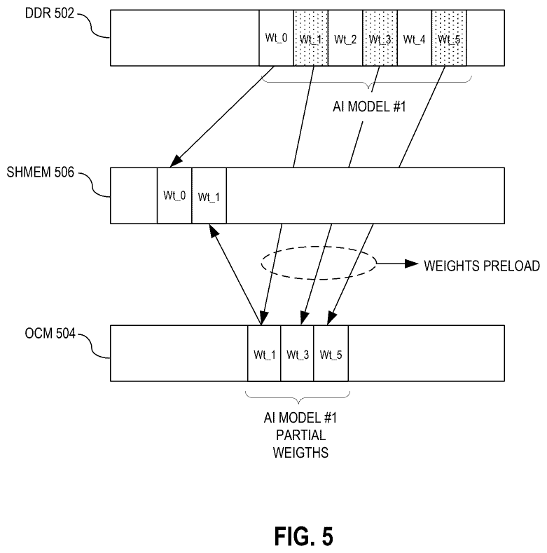

For very large models, the OCM may not have sufficient space to fit all of the weights. In such cases, weights from a large model can be split, with a portion of the weights preloaded into the OCM and the rest remaining in the DDR. FIG. 5 illustrates an exemplary scenario of splitting the weights between on-chip and off-chip memories, according to one embodiment of the instant application. In FIG. 5, weights of the different layers of a large AI model (e.g., AI model #1, which can be a deep-learning neural network) can be stored in an off-chip memory (e.g., a DDR 502) and denoted as Wt_0, Wt_1, . . . Wt_5. Before the execution of AI model #1, all of its weights may be stored in DDR 502. During the execution of the AI model, the weight files can be preloaded into an on-chip memory (e.g., an OCM 504) to reduce the latency.

Due to the large size of the model and the limited space of OCM 504, not all weights can be preloaded to OCM 504. In this example, weights from every other layer (e.g., Wt_1, Wt_3, and Wt_5) can be preloaded into OCM 504, whereas the other weights (e.g., Wt_0, Wt_2, and Wt_4) remain in DDR 502. During inference, weights can be loaded into the shared memory (SHMEM) 506 from DDR 502 and OCM 504 to be used by the AI accelerators for computation at each layer. For example, Wt_0 can be loaded from DDR 502, and Wt_1 can be loaded from OCM 504 to SHMEM 506. Other splitting schemes can also be possible. In an alternative example, weights of the first few layers (e.g., Wt_0, Wt_1, and Wt_2) can be preloaded into OCM 504, whereas weights from other layers (e.g., Wt_3, Wt_4, and Wt_5) remain in DDR 502.

Unlike the process shown in FIG. 4, in which all weights of a model are preloaded into the OCM by the scheduler without the involvement of the AI compiler, the process for preloading a portion or portions of the weights into the OCM requires the involvement of the AI compiler. More specifically, the AI compiler can determine the timing and the size of the weights to be preloaded from the DDR to the OCM and generate a DRAM operator accordingly. This DRAM operator can be similar to the one used for transferring intermediate data from the SHMEM to the OCM. The DRAM operator can specify the offset address (i.e., the size of the preloaded weight portion) and include an address-select field indicating to the firmware to use OCM base address when performing the data loading.

In the example shown in FIG. 5, the AI compiler determines the offset address of each weight portion based on the size of the weights in each model layer. Given that the AI compiler typically compiles one model at a time, the preload of the weights is usually performed for a single model. In practice, multiple models can run concurrently in a system. To reduce the weight-loading latency for multiple models, it may be desirable to preload weights from the multiple models into the OCM. Due to the size constraint of the OCM, not all models can have all weights preloaded into the OCM. In some embodiments, a multi-model optimizer can be used to handle the preload of weights from multiple models. More specifically, the multi-model optimizer can evaluate the sizes of the weights associated with the different models to determine an optimal strategy for preloading the weights into the OCM. In some embodiments, while determining the weight preload strategy, the multi-model optimizer can take into consideration each model's priority, sizes of activation and weights, available space in the SHMEM, and available space in the OCM. In one example, the multi-model optimizer can determine to preload all weights of high-priority models into the OCM. In a different example, the multi-model optimizer can determine that weights of smaller models should be preloaded into the OCM in their entirety, whereas weights of larger models can be split between the OCM and the DDR.

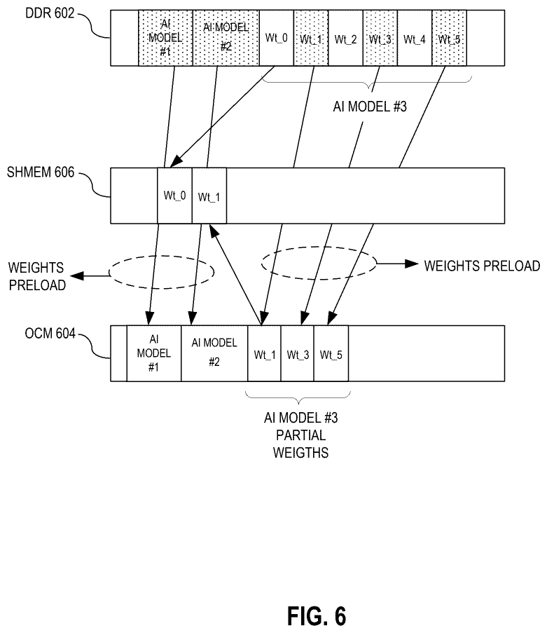

FIG. 6 illustrates an exemplary scenario of preloading weights of multiple models, according to one embodiment of the instant application. In the example shown in FIG. 6, multiple AI models (e.g., AI models #1, #2, and #3) are running concurrently. Model parameters (e.g., weights) of the multiple models can be stored in DDR 602 initially (e.g., when the models are loaded into the system). AI models #1 and #2 can be relatively smaller, with their weights occupying a smaller space in DDR 602 than AI model #3.

When the AI models are executed concurrently, all weights from AI models #1 and #2 can be preloaded into OCM 604. On the other hand, only a portion of the weights of AI model #3 is preloaded into OCM 604. In this example, the weights of every other layer (e.g., Wt_1, Wt_3, and Wt_5) may be preloaded into OCM 604, while other weights (e.g., Wt_0, Wt_2, and Wt_4) can remain in DDR 602. During inference, the weights of AI model #3 (e.g., Wt_0 and Wt_1) can be loaded from DDR 602 and OCM 604 into SHMEM 606.

By transferring intermediate data and preloading model weights, either entirely or partially, into the OCM, the proposed solution can reduce the inference latency due to the smaller access latency of the OCM in comparison with the DDR. Moreover, the data transferring and weight preloading can be managed by the AI compiler, the scheduler, and the firmware without requiring modifications to the memory hardware, making the process highly flexible. This solution can be scalable and covers many different scenarios, ranging from small models to large models and from single model to multiple models.

### Latency Reduction Via Weight Skipping

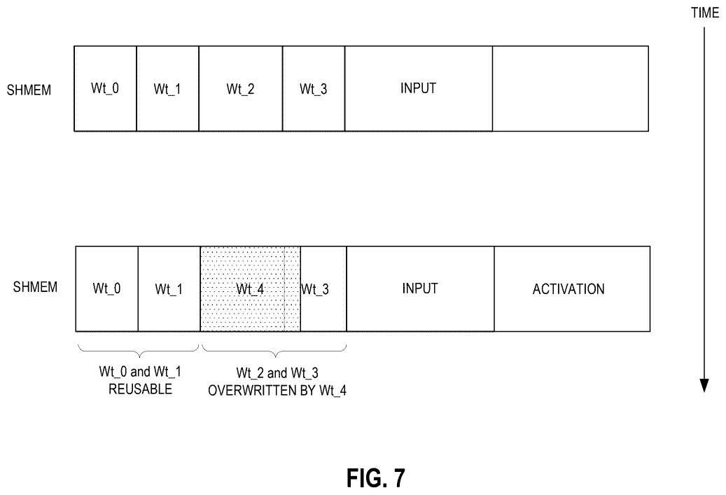

In some embodiments, to further reduce latency, especially the latency caused by loading weights into the SHMEM (either from the DDR or OCM) during inference, one may choose to reuse certain data from the last inference given that the data is still valid. FIG. 7 illustrates an exemplary weight-reuse scenario, according to one embodiment of the instant application. In FIG. 7, at the beginning of the inference, weights from the initial few layers of the model (e.g., Wt_0, Wt_1, Wt_2, and Wt_3) and input data can be loaded into the shared memory accessible by the accelerators.

As time progresses and the inference continues, intermediate data (e.g., activation tensors) and weights from subsequent layers (e.g., Wt_5) can be loaded into the SHMEM. Due to the limited size of the SHMEM, the newly loaded data may overwrite data that is no longer needed by the current inference (e.g., weights of previous layers). However, not all data in the SHMEM will be overwritten by the newly loaded data. In the example shown in FIG. 7, Wt_4 is loaded into the SHMEM, overwriting Wt_2 and Wt_3, whereas Wt_0 and Wt_1 in the SHREM remain unchanged and may be reused by subsequent inference.

In conventional systems, to perform subsequent inference, the system needs to reload weights from the DDR into the SHMEM, which can take time. Considering that certain weights already exist in the SHMEM (e.g., Wt_0 and Wt_1 shown in FIG. 7), the system may be configured to skip the loading of those reusable weights during the subsequent inference, thus reducing latency. To facilitate the weight skipping, the system needs to identify which weight is already in the SHMEM and can be skipped, which requires collaboration among the AI compiler, the scheduler, and the data-loading firmware. More specifically, the compiler can determine that a particular weight currently in the SHMEM is not overwritten by other nodes in the current model, the scheduler can determine that the model used for the current inference is the same as the previous inference and that the SHMEM base address of the DAG used for the current inference is the same as the previous inference, and the data-loading firmware can skip the loading of that particular weight into the SHMEM.

The AI compiler is responsible for compiling the AI models (e.g., generating DAGs and meta files) and managing the loading of the weights from the DDR or OCM into the SHMEM. Each AI model can be associated with a model ID, and each DAG representing the AI model can be associated with a DAG ID or sequence number (e.g., 0, 1, 2, . . . ). To distinguish the different models concurrently running in the system, the AI compiler can generate a unique hash code for each DAG based on the model ID and the DAG ID. In some embodiments, the AI compiler can include the unique hash code in the meta file associated with the model to facilitate the scheduler in identifying each model and DAG.

For a weight file to be reusable in subsequent inference, it should remain persistent in the SHMEM throughout the inference. In other words, it will not be overwritten by data subsequently loaded into the SHMEM. Because the AI compiler manages the loading of the weights, it is aware of which weight files are persistent in the SHMEM. In some embodiments, the AI compiler can use a flag (e.g., a persistent bit) in the DRAM write operator to indicate whether a piece of weight data will be overwritten by subsequent nodes within the same DAG. If the flag associated with a weight file is set (i.e., the persistent bit equals one), the weight file will not be overwritten by other weight files from the same model. Note that the term “persistent” used here means that weight in the SHMEM remains unchanged for the duration of the inference based on the DAG.

A persistent weight file can be reused in a subsequent inference if and only if the subsequent inference is using the same DAG as the previous inference and the subsequent DAG is stored at the same location in the SHMEM. Because the scheduler is responsible for task scheduling, it can determine whether the current inference DAG is the same as the previous one. In some embodiments, the scheduler can compare the model ID and DAG ID associated with the current inference with the model ID and DAG ID associated with the previous inference. If they remain the same, the current inference uses the same DAG as the previous inference.

The same DAG may be loaded into different places in the SHMEM for different inferences. Therefore, to ensure that a persistent weight file can be reused, the scheduler needs to make sure that the current inference stores the DAG at the same memory location as the previous inference. In some embodiments, the scheduler can check the SHMEM base address of the data (e.g., weight files) for the current inference and compare it with the SHMEM base address of the previous inference. Moreover, the scheduler can check whether the SHMEM memory location for the previous DAG has been overwritten by other DAGs.

In some embodiments of the instant application, the scheduler can set a skip_weight bit in a command (e.g., the executing_DAG command) sent to the firmware to indicate that the conditions for skipping the persistent weight are met (i.e., the DAG used in the current inference is the same as the previous one and that the SHMEM base address of the DAG data is the same as the previous one).

During inference, before loading a weight file into the SHMEM, the data-loading firmware can examine the skip_weight bit in the command received from the scheduler and the persistent bit in the DRAM operator associated with the weight file. If both bits are set, the data-loading firmware can skip the loading of this weight file and move on to the next weight file, thus reducing the time needed for loading weights.

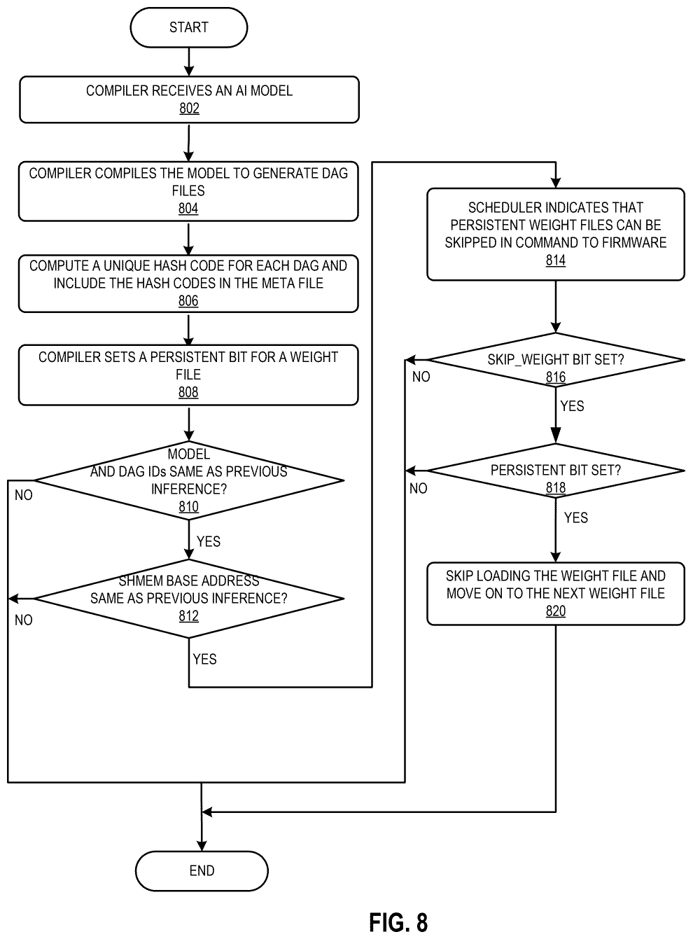

FIG. 8 presents a flowchart illustrating an exemplary process for skipping the loading of a weight file, according to one embodiment of the instant application. During operation, the AI compiler can receive an AI model (operation 802) and compile the model to generate one or more DAG files (operation 804). The AI compiler can also compute a unique hash code for each DAG file based on the model ID and the DAG ID and include the unique hash code in the meta file associated with the model (operation 806). The AI compiler can also set a persistent bit for a weight file to be loaded into the SHMEM, indicating that the weight file will not be overwritten by other nodes of the same DAG (operation 808).

The scheduler can parse the meta file generated by the compiler to determine whether the current model ID and DAG ID are the same as the model ID and DAG ID of the previous inference (operation 810). If not, the current inference uses a different model or DAG, the system cannot skip the loading of any weight, and the process ends. Otherwise, the scheduler can determine whether the SHMEM base address of the DAG data is the same as the previous inference (operation 812). If not, the weight files of the DAG are stored at a different memory location and cannot be reused. The process ends. Otherwise, the scheduler can indicate in a command to the data-loading firmware that persistent weight files can be skipped (operation 814). In some embodiments, the scheduler can set a skip_weight bit in the command (e.g., an executing_DAG command) sent to the data-loading firmware.

When performing the inference by executing the DAG, the data-loading firmware can first determine whether the skip_weight bit in the executing_DAG command is set (operation 816). If not, the process ends. If so, the data loading firmware determines whether the persistent bit in the DRAM operator associated with a to-be-loaded weight file is set (operation 818). If not, the weight file cannot be reused, and the data loading firmware loads the weight file from the DDR (or OCM when applicable) to the SHMEM to allow the AI accelerators to perform the inference. If the persistent bit is set (i.e., the to-be-loaded weight file is already in the SHMEM), the data-loading firmware can skip the loading of this weight file and move on to the next weight file (operation 820).

The proposed solution for allowing the data-loading firmware to skip the loading of certain weights requires zero overhead and can find applications in models of various sizes, from small models to large models. The reduced data-loading latency can increase the frame rate of the machine learning system. Moreover, the weight-skipping scheme can reduce the amount of data requested from the DDR, thus benefiting other applications running in the system as they also share DDR.

### Apparatus and Computer System

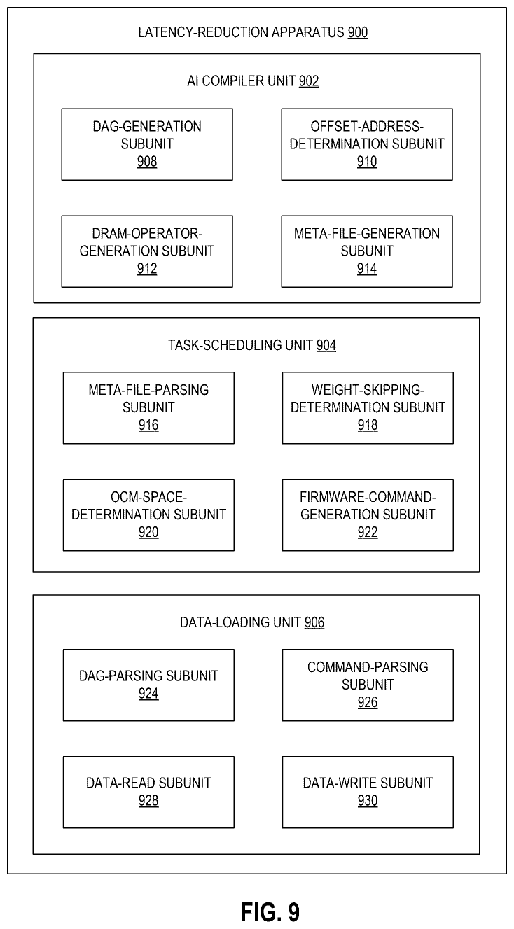

FIG. 9 illustrates an exemplary latency-reduction apparatus for autonomous driving applications, according to one embodiment of the instant application. In FIG. 9, a latency-reduction apparatus 900 can include an AI compiler unit 902, a task-scheduling unit 904, and a data-loading unit 906. The various units and subunits in latency-reduction apparatus 900 can be implemented using hardware, software, firmware, or a combination thereof.

AI compiler unit 902 can include a DAG-generation subunit 908, an offset-address-determination subunit 910, a DRAM-operator-generation subunit 912, and a meta-file-generation subunit 914.

DAG-generation subunit 908 can be responsible for compiling a received AI model to generate one or more DAGs, with each DAG comprising a plurality of interconnected nodes arranged into multiple layers. Offset-address-determination subunit 910 can be responsible for determining the offset address (i.e., the size) of various types of data associated with the DAGs. For example, weights for all nodes within a DAG layer can be placed in a weight file, and the offset address is the amount of memory space needed for storing the weight file. Moreover, in situations where intermediate data is to be spilled to the OCM, offset-address-determination subunit 910 can determine the offset address (i.e., the size) of the to-be-spilled intermediate data. Similarly, in situations where partial weights of a model can be preloaded from the DDR to the OCM, offset-address-determination subunit 910 can determine the offset address (i.e., the size) of the weight file(s) to be preloaded into the OCM.

DRAM-operator-generation subunit 912 can be responsible for generating DRAM operators used for moving data in and out of the SHMEM. For example, a DRAM_out operator can be generated to move intermediate data from the SHMEM to the OCM DRAM-operator-generation subunit 912. Each DRAM operator can include the offset address (e.g., the size) of the data. Moreover, when generating a DRAM operator, DRAM-operator-generation subunit 912 can use an address-select field to indicate the type of base address (e.g., the DDR, OCM, or SHMEM) to be used for the DRAM operation. The address-select field can also indicate the type of the to-be-transferred data, such as input, weight, intermediate data, etc. For example, if the DRAM_out operator is for spilling intermediate data, and the address-select field can be set as 4, indicating that the data is to be spilled to the OCM, and the OCM base address should be used. In another example, a DRAM_in operator can be used for loading the input, the address-select field can be set as 0, indicating that the data is input data to be loaded from the DDR and DDR base address should be used. Moreover, DRAM-operator-generation subunit 912 can set a persistent bit in the DRAM operator if a weight file is determined to be persistent in the SHMEM within the duration of the inference.

Meta-file-generation subunit 914 can be responsible for generating a meta file associated with a compiled AI model. The meta file can include various information about the model and one or more model-execution parameters chosen by the compiler. In some embodiments, the meta file can include the model ID, the IDs of the DAGs, the priority of the model, the size of the weight files, peak OCM usage, etc. The model and DAG IDs allow the scheduler to recognize the DAG used for each inference, thus facilitating the weight-skipping operation. Information about the size of the weights can be useful when the scheduler preloads weights into the OCM from the DDR. The peak OCM usage can indicate the maximum amount of intermediate data to be spilled to the OCM during inference.

Task-scheduling unit 904 can include a meta-file-parsing subunit 916, a weight-skipping-determination subunit 918, an OCM-space-determination subunit 920, and a firmware-command-generation subunit 922.

Meta-file-parsing subunit 916 can be responsible for parsing the meta file associated with a compiled AI model. Weight-skipping-determination subunit 918 can be responsible for determining whether the weight-skipping feature is turned on and whether persistent weight files can be skipped when loading the weights from a DDR (or OCM) into the SHMEM during inference. In some embodiments, weight-skipping-determination subunit 918 can determine that persistent weight files do not need to be reloaded into the SHMEM if and only if the current inference is based on the same model and DAG of a previous inference, and the current inference uses the same SHMEM base address for storing the DAG data as the previous inference.

OCM-space-determination subunit 920 can be responsible for determining the available space on the OCM. In situations where intermediate data is to be spilled to the OCM, OCM-space-determination subunit 920 can determine whether there is enough OCM space to accommodate the data spill. If not, OCM-space-determination subunit 920 can generate an error. In situations where weights are to be preloaded into the OCM, OCM-space-determination subunit 920 can determine whether there is enough OCM space for storing all weights of a model.

Firmware-command-generation subunit 922 can be responsible for generating commands to be sent to the firmware. For example, firmware-command-generation subunit 922 can generate an executing_DAG command that can be executed by the firmware to transfer data into and out of the SHMEM. The executing_DAG command can include the SHMEM base address for writing and reading the data.

Data-loading unit 906 can include a DAG-parsing subunit 924, a command-parsing subunit 926, a data-read subunit 928, and a data-write subunit 930.

DAG-parsing subunit 924 can be responsible for parsing the DAG files generated by AI-compiler unit 902. For example, when spilling intermediate data or preloading the weights to the OCM, DAG-parsing subunit 924 can parse the DRAM operators generated by DRAM-operator-generation unit 912 to determine the type of base address (e.g., DDR or OCM) to be used for the DRAM operation and the offset address.

Command-parsing subunit 926 can be responsible for parsing the commands (e.g., the executing_DAG command) sent by task-scheduling unit 904. In one example, in situations where intermediate data are to be spilled to the OCM, command-parsing subunit 926 can parse an executing _DAG command to determine the OCM base address for storing the spilled intermediate data. The actual address for storing the spilled data can be calculated based on the base address included in the executing _DAG command and the offset address included in the DRAM operator.

Data-read subunit 928 can be responsible for reading data from a memory location (e.g., a location in the SHMEM, OCM, or DDR). Data-write subunit 930 can be responsible for writing data to a memory location (e.g., a location in the SHMEM, OCM, or DDR).

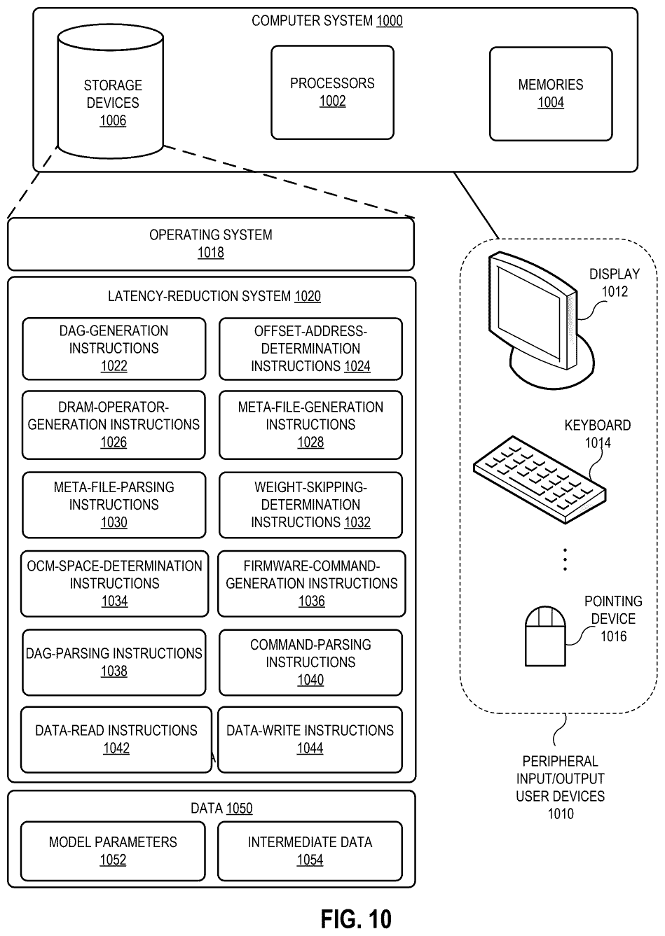

FIG. 10 illustrates an exemplary computer system for performing inference with reduced latency, according to one embodiment of the instant application. Computer system 1000 includes one or more processors 1002, one or more memories 1004, and one or more storage devices 1006. Furthermore, computer system 1000 can be coupled to peripheral input/output (I/O) user devices 1010, e.g., a display device 1012, a keyboard 1014, and a pointing device 1016. Storage devices 1006 can store an operating system 1018, a latency-reduction system 1020, and data 1050. In some embodiments, at least a portion of computer system 1000 can be implemented as part of an advanced driver-assistance system (ADAS) or an automated driving system (ADS) installed on a vehicle.

Latency-reduction system 1020 can include instructions, which when executed by computer system 1000, can cause computer system 1000 or processors 1002 to perform methods and/or processes described in this disclosure. Specifically, latency-reduction system 1020 can include instructions for generating DAG files based on a received AI model (DAG-generation instructions 1022), instructions for determining the offset address of data (offset-address-determination instructions 1024), instructions for generating DRAM operators (DRAM-operator-generation instructions 1026), instructions for generating meta files of the AI models (meta-file-generation instructions 1028), instructions for parsing the meta files (meta-file-parsing instructions 1030), instructions for determining whether the weight-skipping feature is turned on and whether persistent weight files can be skipped (weight-skipping-determination instructions 1032), instructions for determining the available OCM space (OCM-space-determination instructions 1034), instructions for generating firmware commands (firmware-command-generation instructions 1036), instructions for parsing the DAG files (DAG-parsing instructions 1038), instructions for parsing the firmware commands (command-parsing instructions 1040), instructions for reading data from a memory location (data-reading instructions 1042), and instructions for writing data to a memory location (data-write instructions 1044). Data 1050 can include model parameters (e.g., weights) 1052 and intermediate data 1054.

In general, this disclosure presents a solution to the problem of reducing machine learning inference latency for autonomous driving applications. The proposed solution reduces the inference latency by reducing the latency for loading weights and intermediate data. In some embodiments of the instant application, an AI chip or SOC can include, in addition to a memory directly accessible by the AI accelerators (referred to as a shared memory or a primary memory), an on-chip memory with addresses mapped to the DDR address space (referred to as an OCM or secondary memory). Compared with traditional AI systems that store weights and intermediate data in off-chip DDR memories, the proposed AI system can use the OCM to store certain model data. During inference, the AI system can be configured to preload some model parameters (e.g., weights) from the DDR to the OCM and spill intermediate data from the SHMEM to the OCM. Moreover, between inferences, model parameters that remain unchanged in the SHMEM can be reused. Accordingly, the AI system can be configured to skip the loading of those unchanged model parameters when performing a subsequent inference. A collection of software and firmware units within the AI system, including the AI compiler, the task scheduler, and the data-loading firmware, can collaborate with each other to perform latency-reduction operations.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices, solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the optimized parameters from the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A computer-implemented method for reducing inference latency of an artificial intelligence (AI) system, the method comprising:
obtaining an AI model;
compiling the AI model to generate at least one Directed Acyclic Graph (DAG), which comprises determining an offset address associated with a piece of intermediate data to be transferred from a primary memory shared among multiple AI accelerators to a secondary memory, wherein the AI accelerators, the primary memory, and the secondary memory are located on a same system on a chip (SoC);
scheduling computing tasks for the inference, which comprises determining a base address associated with the DAG in the secondary memory; and
performing the inference based on the DAG, which comprises transferring the piece of intermediate data from the primary memory to the secondary memory based on the offset address and the base address.

2. The method of claim 1, wherein the primary memory or the secondary memory includes a static random-access memory (SRAM).

3. The method of claim 1, wherein receiving the AI model comprises storing weight files associated with the AI model in an off-chip memory.

4. The method of claim 3, further comprising, preloading, prior to the inference, at least a portion of the weight files from the off-chip memory into the secondary memory, thereby reducing the inference latency resulting from loading the weight files into the primary memory to allow the multiple AI accelerators to perform computations based on the weight files.

5. The method of claim 4, further comprising preloading one or more weight files associated with a second model into the secondary memory.

6. The method of claim 1, wherein performing the inference comprises loading weight files associated with the DAG into the primary memory, and wherein loading the weight files comprises skipping a weight file that pre-exists in the primary memory.

7. The method of claim 6, wherein skipping the weight file comprises:
determining that the DAG remains unchanged from a previous inference;
determining that a base address in the primary memory corresponding to the DAG remains unchanged from the previous inference; and
determining that the weight file is persistent during the previous inference.

8. The method of claim 6, wherein generating the DAG comprises generating a memory operator associated with the weight file and setting a persistent bit in the memory operator.

9. The method of claim 6, wherein scheduling the computing tasks comprises generating a data-loading command associated with the DAG and setting a skip_weight bit in the data-loading command.

10. A computing system, comprising:
a processor; and
a memory coupled to the processor and storing instructions that when executed by the processor cause the processor to perform a method for reducing inference latency of an artificial intelligence (AI) system, the method comprising:
obtaining an AI model;
compiling the AI model to generate at least one Directed Acyclic Graph (DAG), which comprises determining an offset address associated with a piece of intermediate data to be transferred from a primary memory shared among multiple AI accelerators to a secondary memory, wherein the AI accelerators, the primary memory, and the secondary memory are located on a same system on a chip (SoC);
scheduling computing tasks for the inference, which comprises determining a base address associated with the DAG in the secondary memory; and
performing the inference based on the DAG, which comprises transferring the piece of intermediate data from the primary memory to the secondary memory based on the offset address and the base address.

11. The computing system of claim 10, wherein the primary memory or the secondary memory includes a static random-access memory (SRAM).

12. The computing system of claim 10, wherein receiving the AI model comprises storing weight files associated with the AI model in an off-chip memory.

13. The computing system of claim 12, wherein the method further comprises, preloading, prior to the inference, at least a portion of the weight files from the off-chip memory into the secondary memory, thereby reducing the inference latency resulting from loading the weight files into the primary memory to allow the multiple AI accelerators to perform computations based on the weight files.

14. The computing system of claim 13, wherein the method further comprises preloading one or more weight files associated with a second model into the secondary memory.

15. The computing system of claim 11, wherein performing the inference comprises loading weight files associated with the DAG into the primary memory, and wherein loading the weight files comprises skipping a weight file that pre-exists in the primary memory.

16. The computing system of claim 15, wherein skipping the weight file comprises:
determining that the DAG remains unchanged from a previous inference;
determining that a base address in the primary memory corresponding to the DAG remains unchanged from the previous inference; and
determining that the weight file is persistent during the previous inference.

17. The computing system of claim 15, wherein generating the DAG comprises generating a memory operator associated with the weight file and setting a persistent bit in the memory operator.

18. The computing system of claim 15, wherein scheduling the computing tasks comprises generating a data-loading command associated with the DAG and setting a skip_weight bit in the data-loading command.

19. An artificial intelligence (AI) system, comprising:
a plurality of AI accelerators;
a primary memory shared among multiple AI accelerators;
a secondary memory, wherein the AI accelerators, the primary memory, and the secondary memory are located on a same system on a chip (SoC);
an AI compiler to compile an AI model to generate at least one Directed Acyclic Graph (DAG), which comprises determining an offset address associated with a piece of intermediate data to be transferred from the primary memory to the secondary memory;
a task-scheduling unit to schedule computing tasks for inference, which comprises determining a base address associated with the DAG in the secondary memory; and
data-loading firmware to transfer, during the inference, the piece of intermediate data from the primary memory to the secondary memory based on the offset address and the base address.

20. The AI system of claim 19, wherein the data-loading firmware is to preload, prior to the inference, at least a portion of the weight files from the off-chip memory into the secondary memory, thereby reducing the inference latency resulting from loading the weight files into the primary memory to allow the multiple AI accelerators to perform computations based on the weight files.
